(19) United States
(12) Patent Application Publication
(10) Pub. No.: US 2007/0011840 A1
(43) Pub. Date: Jan. 18, 2007

(54) Windscreen wiper arm

(75) Inventor: Marco Gilli, Chieri (IT)

Correspondence Address: DICKINSON WRIGHT PLLC, 38525 WOODWARD AVENUE, SUITE 2000, BLOOMFIELD HILLS, MI, 48304-2970, US

(73) Assignee: FEDERAL-MOGUL S.A., AUBANGE (BE)

(21) Appl. No.: 10/570,799

(22) PCT Filed: Sep. 2, 2004
(86) PCT No.: PCT/EP04/52015

§ 371 Date: Mar. 3, 2006

(30) Foreign Application Priority Data
Sep. 11, 2003 (EP) 03103349.1

(51) Int. Cl. B60S 1/34

(52) U.S. Cl. 15/250.352; 15/250.351; 15/250.43

(57) ABSTRACT

A windscreen wiper arm (8), particularly for automobiles, comprising a mounting head (18) mountable on a drive shaft (19) and an arm member (20) pivotally connected to the mounting head (18) by means of a pivot pin (21), wherein the arm member (20) has a substantially U-shaped cross-section near said pivot pin (21) comprising two side walls (25, 26), wherein a part of the mounting head (18) extends between the side walls (25, 26) and beyond said pivot pin (21), with the special feature that protrusion/groove means are provided on said part (18) and said side walls (25, 26) for limiting a pivot angle of the arm member (20), wherein the protrusion/groove means comprise at least one curved guiding groove (30) and at least one protrusion (29) cooperating with said groove (30).

### CROSS REFERENCE TO RELATED APPLICATIONS

This patent application claims priority to PCT/EP2004/052015 having an International Filing Date of Sep. 2, 2004 which also claims priority to EP patent application 03103349.1 filed Sep. 11, 2003, all of which are incorporated herein by reference in their entirety.

### BACKGROUND OF THE INVENTION

1. Field of the Invention

The present invention relates to a windscreen wiper arm, particularly for automobiles, comprising a mounting head mountable on a drive shaft and an arm member pivotally connected to the mounting head by means of a pivot pin, wherein the arm member has a substantially U-shaped cross-section near said pivot pin comprising two side walls, wherein a part of the mounting head extends between the side walls and beyond said pivot pin.

2. Related Art

Such a windscreen wiper arm is known from European patent publication no. 0 755 833 (Valeo Systèmes d'Essuyage). The windscreen wiper arm and the mounting head described in this European patent document are equipped with complementary stop surfaces cooperating together in order to limit a pivot angle of the windscreen wiper arm. More in particular, a pivot movement of the known windscreen wiper arm relative to the known mounting head in a direction away from a windscreen to be wiped, is blocked beyond a certain maximum pivot angle, with the help of a protrusion on the windscreen wiper arm stopped by a stop surface on the mounting head.

A disadvantage of the windscreen wiper arm known from the above European patent publication is that, due to the fact that many cars have their own specifications as to a maximum pivot angle referred to above, for those cars a specific windscreen wiper arm and mounting head has to be designed and manufactured. Obviously, this needs complex machinery, tools, with all the expenses involved.

It is an object of the invention to obviate this disadvantage, in the sense that at minimum costs-without using complex machinery and additional tools—windscreen wiper arms with mutually minimum modifications are proposed, which can be mounted on different cars. It is noted that the present invention is not restricted to cars, but also refers to rail coaches and other (fast) vehicles.

Thereto, according to the invention a windshield wiper arm mentioned in the preamble is characterized in that protrusion/groove means are provided on said part and said side walls for limiting a pivot angle of the arm member, wherein the protrusion/groove means comprise at least one curved guiding groove and at least one protrusion cooperating with said groove. Particularly, said protrusion is movable in said groove between a first position corresponding with a wiping position of the arm member and a second position corresponding with a mounting position of the wiping arm.

This enables to mount windscreen wiper arms mutually only differing in the sense that only the shape (particularly the effective length) of the groove is modified by using a small modification in the respective mould, on every type of car.

In a preferred embodiment of a windscreen wiper device in accordance with the invention said part is provided with opposite abutting surfaces for abutting against the side walls, wherein said protrusion extends laterally inwardly from one of the side walls into said groove being provided on one of the abutting surfaces abutting against that respective side wall. In the alternative, said part is provided with opposite abutting surfaces for abutting against the side walls, wherein said protrusion extends laterally outwardly from one of the abutting surfaces into said groove being provided on one of the side walls abutting against that respective abutting surface.

In another preferred embodiment of a windscreen wiper device according to the invention said groove extends along a part of a circle.

In another preferred embodiment of a windscreen wiper device in accordance with the invention the arm member is made of a plastic material. Preferably, also the mounting head is made of a plastic material.

The invention refers also to a mounting head and/or an arm member as defined in a windscreen wiper arm according to the invention.

The invention also relates to a windscreen wiper device comprising a windscreen wiper arm in accordance with the invention. Particularly, said windscreen wiper device comprises an elastic, elongated carrier element, as well as an elongated wiper blade of a flexible material, which can be placed in abutment with a windscreen to be wiped, which wiper blade includes opposing longitudinal grooves on its longitudinal sides, in which grooves spaced-apart longitudinal strips of the carrier element are disposed, wherein neighbouring ends of said longitudinal strips are interconnected by a respective connecting piece, which windscreen wiper device comprises a connecting device for the windscreen wiper arm in accordance with the invention. Such a windscreen wiper device is thus designed as a “yokeless” wiper device, wherein use is no longer made of several yokes pivotally connected to each other, but wherein the wiper blade is biassed by the carrier element, as a result of which it exhibits a specific curvature. The present windscreen wiper arm may comprise a pivot pin on one side thereof, which is inserted sideways into a through hole of the connecting device. It is noted that the present invention is not restricted to such a “yokeless blade”, although being advantegeous therein, but also extends to other types of windscreen wiper devices, such as the ones with yokes as referred to above.

Finally, the invention also refers to a method for manufacturing a windscreen wiper arm, particularly for automobiles, comprising a mounting head mountable on a drive shaft and an arm member pivotally connected to the mounting head by means of a pivot pin, wherein the arm member has a substantially U-shaped cross-section near said pivot pin comprising two side walls, wherein a part of the mounting head extends between the side walls and beyond said pivot pin, characterized in that protrusion/groove means are provided on said part and said side walls for limiting a pivot angle of the arm member, wherein the protrusion/groove means are provided with at least one curved guiding groove and at least one protrusion cooperating with said groove.

### BRIEF DESCRIPTION OF THE DRAWINGS

The invention will now be explained in more detail with reference to figures illustrated in a drawing, wherein:

FIG. 1 is a perspective, schematic view of a preferred embodiment of a windscreen wiper device equipped with a windscreen wiper arm according to the invention, wherein the windscreen wiper arm is in a wiping position;

FIGS. 2 through 7 show details of the windscreen wiper device of FIG. 1;

FIG. 8 is a bottom view of the windscreen wiper arm of FIG. 1;

FIG. 9 corresponds to FIG. 1, with the difference that the windscreen wiper arm is now in a mounting position; and

FIGS. 10 and 11 are details of FIG. 9 according to different embodiments.

### DETAILED DESCRIPTION OF THE PREFERRED EMBODIMENT

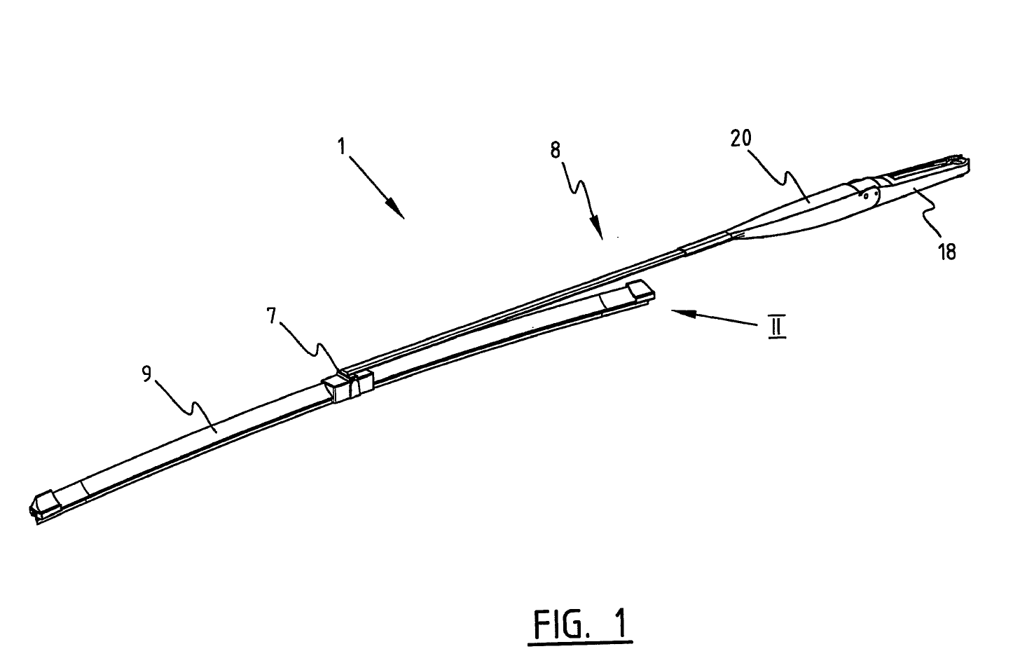

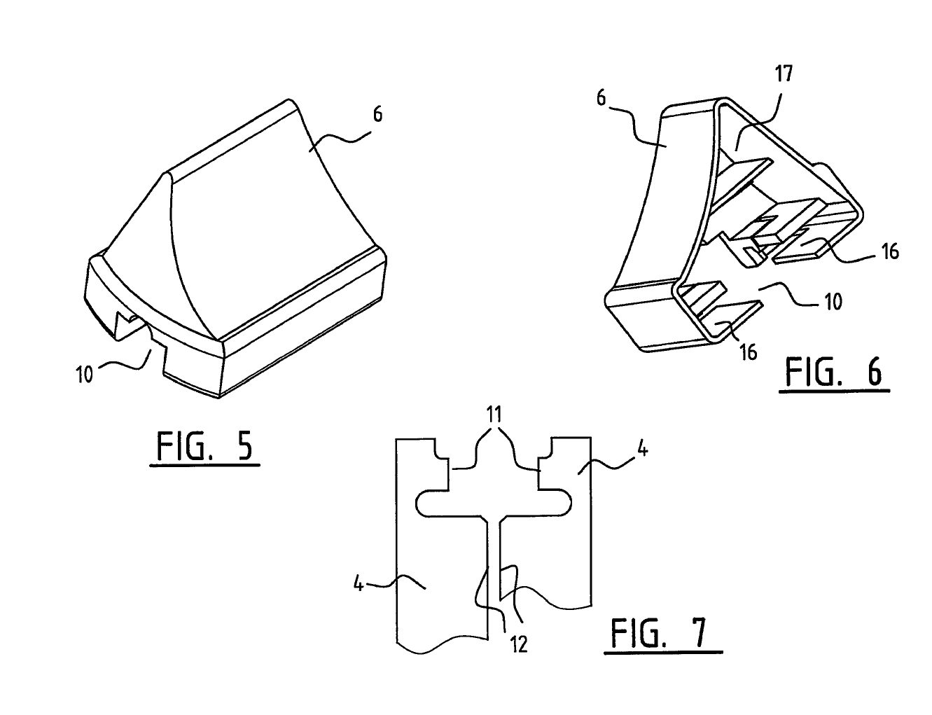

FIG. 1 through 7 show a preferred variant of a windscreen wiper device 1 according to the invention. Said windscreen wiper device is built up of an elastomeric wiper blade 2, in the longitudinal sides of which opposing longitudinal grooves 3 are formed, and of longitudinal strips 4 made of spring band steel, which are fitted in said longitudinal grooves 3.

Said strips 4 form a flexible carrier element for the rubber wiper blade 2, as it were, which is thus biassed in a curved position (the curvature in operative position being that of a windscreen to be wiped). Neighbouring ends 5 of strips 4 are interconnected on either side of the windscreen wiper device 1 by means of connecting pieces 6. The windscreen wiper device 1 is further equipped with a connecting device 7 for an oscillating arm 8, and a spoiler 9.

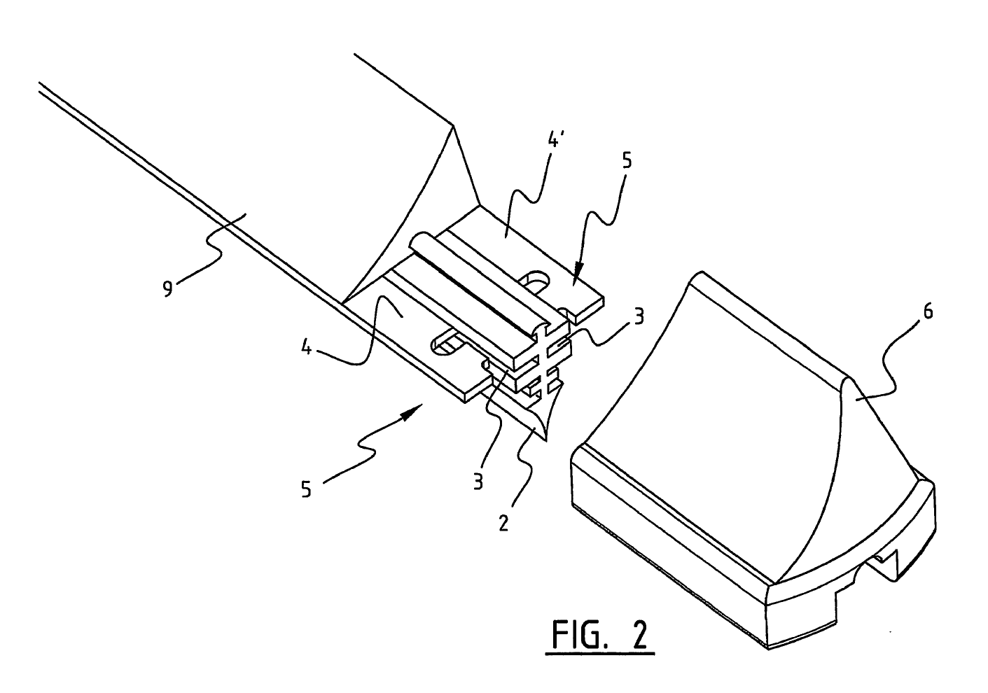

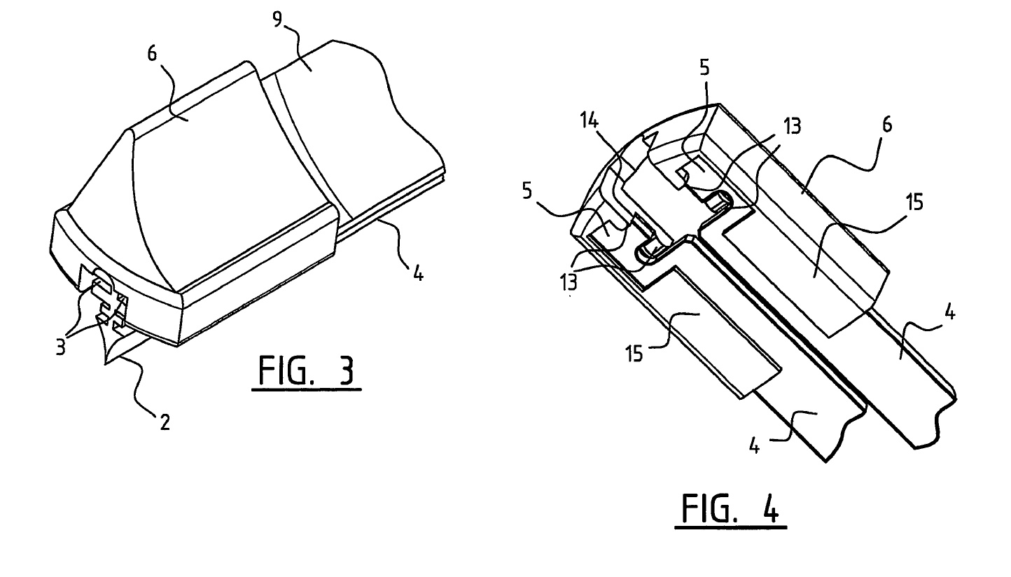

FIGS. 2 and 3 show a free end of the windscreen wiper device 1 of FIG. 1, whereas FIG. 4 reveals a bottom view of said free end without the wiper blade 2 being present. Corresponding parts have been designated with the same reference numerals. As can be seen from FIGS. 2,5 and 6 (the latter two figures showing in perspective the connecting piece 6 as a separate constructional element), the connecting piece 6 is provided with an opening 10 in order to allow a relative movement of the wiper blade 2 along the strips 4 inside the connecting piece 6, so that said connecting piece 6 does not block the wiper blade 2 during use. The connecting pieces 6 are made of one piece of plastic.

With reference to FIG. 7 relating to a top view of the strips 4 as such, said strips 4 are each provided with a protrusion 11 extending laterally from a longitudinal interior edge 12 of the strips 4. When a connecting piece 6 is slidably mounted onto the neighbouring ends 5 of the strips 4, a snap or clicking connection is realized, wherein the protrusions 11 are snapped or clicked between stops 13 (“notches 13”) inside the connecting piece 6. Each protrusion 11 rests in a small groove 14 between these opposing stops 13. Accordingly, the strips 4 are blocked against any movement in longitudinal direction with respect to the connecting pieces 6. Each connecting piece 6 is also provided with two engaging members 15 made integral therewith, wherein said engaging members 15 engage around the strips 4 so as to form a groove 16 for sliding the strips 4 therein. Said engaging members 15 ensure that the strips 4 are blocked against any movement in transversal direction with respect to the connecting pieces 6. Each connecting piece 6 has a cavity 17 to accommodate the free end of the spoiler 9.

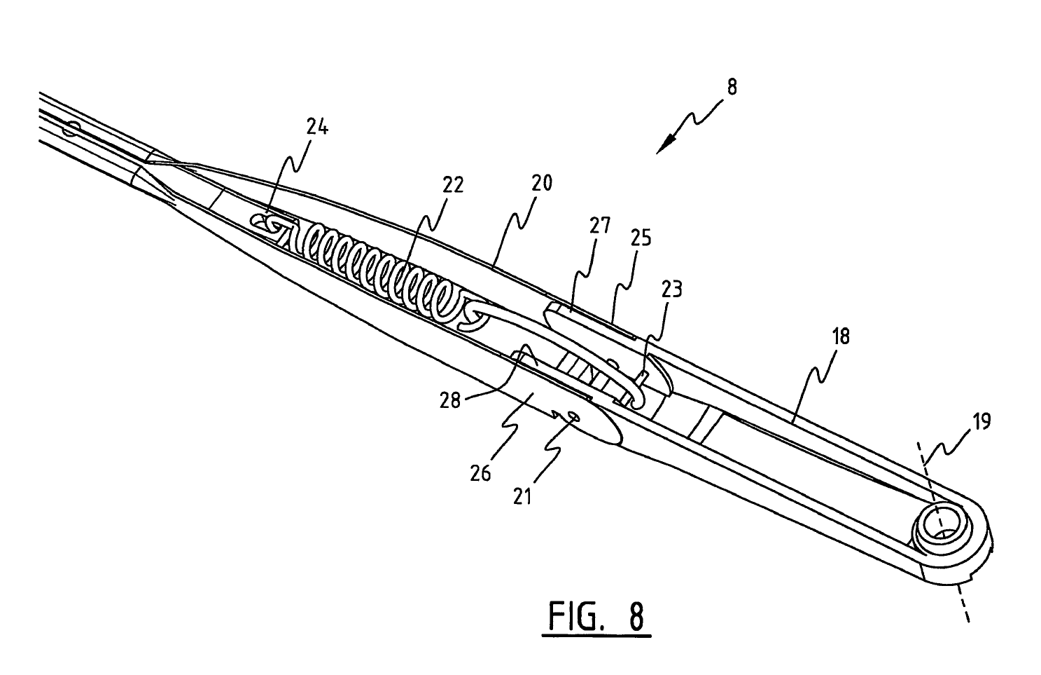

As illustrated in FIGS. 8 through 11 the windscreen wiper arm 8 according to the invention comprises a plastic mounting head 18 which can be fixed for rotation to a shaft 19 driven, via a mechanism not illustrated, by a small motor. Said windscreen wiper arm 8 further comprises a plastic arm member 20 supported by the mounting head 18, wherein said arm member 20 in turn supports the wiper blade 2 with the help of the connecting device 7, as illustrated in FIG. 1. The arm member 20 is pivotally connected to the mounting head 18 by means of a pivot pin 21. A spring 22 is hooked with its first end on a pin 23 on the mounting head 18 and with its second end on to a part 24 of the arm member 20 in order to ensure that the arm member 20 and thus the wiper blade 2 connected thereto is pressed onto a windscreen to be wiped. In use, the shaft 19 rotates alternately in a clockwise and in a counterclockwise sense carrying the mounting head 18 into rotation also, which in turn draws the arm member 20 into rotation and by means of the connecting device 7 moves the wiper blade 2.

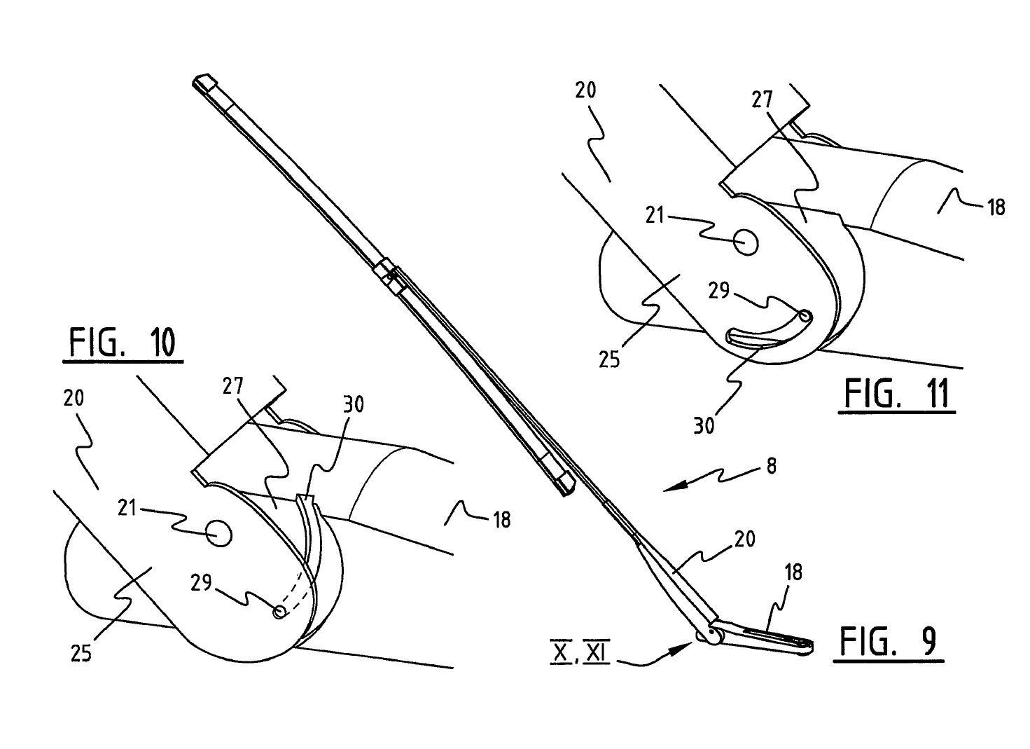

As illustrated, the arm member 20 has a substantially U-shaped cross-section near said pivot pin 21 comprising two side walls 25,26, wherein a part of the mounting head 18 extends between the side walls 25,26 and beyond said pivot pin 21. Said part is provided with opposite abutting surfaces 27,28 for abutting against the side walls 25, 26. A cylindrical protrusion 29 extends laterally inwardly from the side wall 25 into a guiding groove 30 being provided on the abutting surface 27 abutting against the side wall 25. The guiding groove has a shape of a part of a circle, for example a quarter of a half of a circle. When the arm member 20 is pivoted relative to the mounting head 18 from a first position facing towards a windscreen to be wiped (that is a wiping position, see FIG. 1) to a second position facing away from a windscreen to be wiped (that is a mounting, cleaning and/or repair position, for example, see FIG. 9), the protrusion 29 is guided by the guiding groove 30 until a maximum pivot angle is reached. In that case, the protrusion 29 is stopped/blocked by a wall of the guiding groove 30, so that the arm member 20 cannot be pivoted vis-à-vis the mounting head 18 beyond said maximum pivot angle. It will be appreciated that in addition a guiding groove may also be provided on the abutting surface 28 cooperating with a cylindrical protrusion extending laterally inwardly from the side wall 26. In another preferred embodiment a guiding groove 30 is provided on one or both side wall (s) 25,26, whereas a cylindrical protrusion 29 cooperating therewith is present on one or both abutting surface (s) 27,28 (FIG. 11).

The invention is not restricted to the embodiment shown, but extends also to other embodiments falling within the scope of the appended claims.

1. A windscreen wiper arm, comprising a mounting head mountable on a drive shaft and an arm member pivotally connected to the mounting head by means of a pivot pin, wherein the arm member has a substantially U-shaped cross-section near said pivot pin comprising two side walls, wherein a part of the mounting head extends between the side walls and beyond said pivot pin, and a protrusion means and a groove means are provided on one of said part and said at least one side walls wall for limiting a pivot angle of the arm member, wherein the protrusion means and groove means comprise at least one curved guiding groove and at least one protrusion cooperating with said groove.

2. A windscreen wiper device according to claim 1, wherein said protrusion is movable in said groove between a first position corresponding with a wiping position of the arm member and a second position corresponding with a mounting position of the wiping arm.

3. A windscreen wiper arm according to claim 1, wherein said part is provided with opposite abutting surfaces for abutting against the side walls and wherein said protrusion extends laterally inwardly from one of the side walls into said groove being provided on one of the abutting surfaces abutting against that respective side wall.

4. A windscreen wiper arm according to claim 1, wherein said part is provided with opposite abutting surfaces for abutting against the side walls and wherein said protrusion extends laterally outwardly from one of the abutting surfaces into said groove being provided on one of the side walls abutting against that respective abutting surface.

5. A windscreen wiper arm according to claim 1, wherein said groove extends along a part of a circle.

6. A windscreen wiper arm according to claim 1, wherein the arm member is made of a plastic material.

7. A mounting head and an arm member as defined in a windscreen wiper arm according to claim 1.

8. A windscreen wiper device comprising a windscreen wiper arm according to claim 1.

9. A windscreen wiper device according to claim 8, further comprising an elastic, elongated carrier element, as well as an elongated wiper blade of a flexible material, which can be placed in abutment with a windscreen to be wiped, which wiper blade includes opposing longitudinal grooves on its longitudinal sides, in which grooves spaced-apart longitudinal strips of the carrier element are disposed, wherein neighbouring ends of said longitudinal strips are interconnected by a respective connecting piece, which windscreen wiper device also comprises a connecting device for the windscreen wiper arm.

10. Method for manufacturing a windscreen wiper arm, comprising a mounting head mountable on a drive shaft and an arm member pivotally connected to the mounting head by means of a pivot pin, wherein the arm member has a substantially U-shaped cross-section near said pivot pin comprising two side walls, wherein a part of the mounting head extends between the side walls and beyond said pivot pin, comprising a step of:
providing a protrusion means and a groove means on said part and said side walls for limiting a pivot angle of the arm member, wherein the protrusion means and the groove means are provided with at least one curved guiding groove and at least one protrusion cooperating with said groove.

11. A windscreen wiper arm, comprising:
a mounting head mountable on a drive shaft;
an arm member;
a pivot pin which pivotally connects said mounting head and said arm member, wherein the arm member has a substantially U-shaped cross-section near said pivot pin comprising two side walls, and wherein a part of the mounting head extends between the side walls and beyond said pivot pin; and
at least one protrusion and at least one partially circular groove located separately on the respective ones of said part and said side walls in cooperative engagement, and together operative for limiting a pivot angle of the arm member.

12. A windscreen wiper device according to claim 11, wherein said protrusion is movable in said groove between a first position corresponding with a wiping position of the arm member and a second position corresponding with a mounting position of the wiping arm.

13. A windscreen wiper arm according to claim 11, wherein said part is provided with opposite abutting surfaces for abutting against the side walls and wherein said protrusion extends laterally inwardly from one of the side walls into said groove being provided on one of the abutting surfaces abutting against that respective side wall.

14. A windscreen wiper arm according to claim 11, wherein said part is provided with opposite abutting surfaces for abutting against the side walls and wherein said protrusion extends laterally outwardly from one of the abutting surfaces into said groove being provided on one of the side walls abutting against that respective abutting surface.

15. A windscreen wiper arm according to claim 11, wherein the arm member is made of a plastic material.

16. A mounting head or an arm member as defined in a windscreen wiper arm according to claim 11.

17. A windscreen wiper device according to claim 16, further comprising an elastic, elongated carrier element, as well as an elongated wiper blade of a flexible material, which can be placed in abutment with a windscreen to be wiped, which wiper blade includes opposing longitudinal grooves on its longitudinal sides, in which grooves spaced-apart longitudinal strips of the carrier element are disposed, wherein neighbouring ends of said longitudinal strips are interconnected by a respective connecting piece, which windscreen wiper device also comprises a connecting device for the windscreen wiper arm.

18. A windscreen wiper arm, comprising a mounting head mountable on a drive shaft and an arm member pivotally connected to the mounting head by means of a pivot pin, wherein the arm member has a substantially U-shaped cross-section near said pivot pin comprising two side walls, wherein a part of the mounting head extends between the side walls and beyond said pivot pin, and protrusion means and groove means are provided on said part and said side walls for limiting a pivot angle of the arm member.

19. A windscreen wiper arm according to claim 18, wherein said part is provided with opposite abutting surfaces for abutting against the side walls and wherein said protrusion extends laterally inwardly from one of the side walls into said groove being provided on one of the abutting surfaces abutting against that respective side wall.

20. A windscreen wiper arm according to claim 18, wherein said part is provided with opposite abutting surfaces for abutting against the side walls and wherein said protrusion extends laterally outwardly from one of the abutting surfaces into said groove being provided on one of the side walls abutting against that respective abutting surface.
